(19) United States
(12) Patent Application Publication
(10) Pub. No.: US 2007/0200837 A1
(43) Pub. Date: Aug. 30, 2007

(54) DISPLAY DEVICE

(75) Inventors: Chia-Hung Ou, Tao Yuan Shien (TW); Yun-Chen Yeh, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA COMPUTER INC., Tao Yuan Shien (TW)

(21) Appl. No.: 11/425,474

(22) Filed: Jun. 21, 2006

(30) Foreign Application Priority Data
Feb. 24, 2006 (TW) 95106272

(51) Int. Cl. G09G 5/00

(52) U.S. Cl. 345/204

(57) ABSTRACT

A display device comprises a first connector, a communication controller coupled to the first connector to transmit addressed data comprising display data, a display controller receiving the display data to generate video signals, and a display unit receiving and displaying the video signal. The video signals comprise a color signal, a vertical sync signal, and a horizontal sync signal.

### BACKGROUND OF THE INVENTION

1. Field of the Invention

The invention relates to display devices, and in particular to display devices communicating directly with electronic devices and having graphic data processing capability.

2. Description of the Related Art

Conventional monitors, such as Liquid Crystal Display (LCD) and Cathode-Ray Tube (CRT), receive video signals via video signal communication interface. The video signals comprise a color signal, a vertical sync signal, and a horizontal sync signal. Data transmitted by the video signals is bitmap data. The monitor converts the received video signals to bitmap data, and displays images based on pixel mapping thereof.

The video signal communication interface transmits only video signals. Conventional displays are incapable of graphic signal processing. Therefore, the conventional display has to be coupled to a graphic card which generates video signals. To access data stored in a portable electronic device, it is necessary to connect the device to a computer having a graphic card, and then a display coupled to the graphic card displays the data from the portable electronic device, an inconvenient process. Displays which communicate directly with portable electronic devices and have graphic data processing capability are thus desirable.

### BRIEF SUMMARY OF THE INVENTION

The invention provides displays devices having data communication capability. An interface transmits addressed data, and the display device further comprises a display controller and a display unit. The display controller receives display data and generates video signals transmitted to the display unit.

The invention also provides display devices comprising a first connector, a communication controller coupled to the first connector to communicate data comprising display data, a display controller receiving the display data to generate video signals, and a display unit receiving and displaying the video signal. The video signals comprise a color signal, a vertical sync signal, and a horizontal sync signal.

### BRIEF DESCRIPTION OF THE DRAWINGS

The invention can be more fully understood by reading the subsequent detailed description and examples with references made to the accompanying drawings, wherein:

FIG. 1 is a block diagram of a display device 10.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

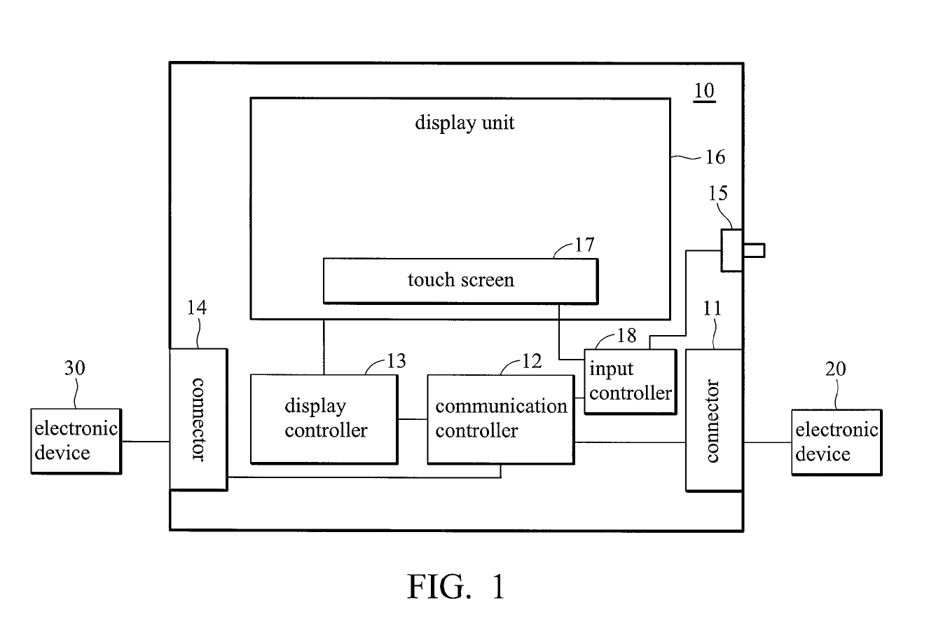

FIG. 1 is a block diagram of a display device 10 of an embodiment of the invention. The display device 10 comprises a first connector 11, a communication controller 12, a display controller 13, and a display unit 16. The display unit 16 can be implemented as a liquid crystal display panel. The first connector 11 can be implemented as an USB connector, a Bluetooth connector, a 1394 connector, a local area network (LAN) connector, or a wireless local area network connector (WLAN).

The first connector 11 is coupled to an electronic device 20 such as a computer or a portable electronic apparatus. It is necessary to initialize an address range in the electronic device 20 for data to be transmitted to the display device 10. According to the address range, the electronic device 20 transmits data to the display device 10 via the first connector 11 and the display unit 16 receives the data.

In the invention, display controller 13 provides the same function as a graphic card in a computer. According to the address range, the electronic device 20 transmits data to the display controller 13 via the first connector 11 and the communication controller 12.

Data received by the display device 10 is addressed data, addressed in the address range of the electronic device 20, and comprises display data. The display data is received and processed by the display controller 13 to generate video signals. The display controller 13 transmits the video signals to a display unit 16.

In the embodiment described in FIG. 1, the electronic device 20 is coupled to the display device 10 without a conventional graphic card. Display unit 16 can display complex images with graphic processing from the display controller 13 rather than conventional graphic card.

The display device 10 further comprises a control 15, a touch screen 17, and an input controller 18. The control 15 and the touch screen 17 generate control signals transmitted to the input controller 18 to generate control data. The input controller 18 transmits the control data to the electronic device 20 via the communication controller 12.

The touch screen 17 and the control 15 provide input to the electronic device 20.

The display device 10 further comprises a second connector 14 coupled to communication controller 12. The second connector 14 can be implemented as a USB connector, a Bluetooth connector, a 1394 connector, a LAN connector, or a WLAN connector. For transmitting data between the electronic devices (20 and 30) and the display device 10, each device has address ranges for other devices. Once the devices are connected, the address ranges in each device are initialized. Based on the address ranges, data can be transmitted between the electronic devices 20 and 30 via the display device 10 rather than communication device.

Electronic devices without a graphic card can display images via the display device of the invention. The display device further acts as an input device for the electronic device. Users can set the status of the electronic device via the display device. The display device can further be coupled to another electronic device and act as a communication platform to transmit data between the electronic devices having independent data communication interfaces.

While the invention has been described by way of example and in terms of preferred embodiment it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising
a first connector;
a communication controller, coupled to the first connector, transmitting addressed data comprising display data via the first connector;
a display controller, receiving the display data to generate video signals comprising a color signal, a vertical sync signal, and a horizontal sync signal; and
a display unit, receiving and displaying the video signals.

2. The display device as claimed in claim 1, wherein the first connector is implemented as a USB connector.

3. The display device as claimed in claim 1, wherein the first connector is implemented as a Bluetooth connector.

4. The display device as claimed in claim 1, wherein the first connector is implemented as a 1394 connector.

5. The display device as claimed in claim 1, wherein the first connector is implemented as a local area network connector.

6. The display device as claimed in claim 1, wherein the first connector is implemented as a wireless local area network connector.

7. The display device as claimed in claim 1, wherein the display unit is implemented as a liquid crystal display panel.

8. The display device as claimed in claim 1 further comprising:
an input device, receiving an external signal to generate a control signal; and
an input controller, receiving the control signal to generate control data transmitted to the communication controller.

9. The display device as claimed in claim 8, wherein the input device is implemented as a touch screen.

10. The display device as claimed in claim 8, wherein the input device is implemented as a button type switch.

11. The display device as claimed in claim 1 further comprising:
a second connector; wherein the communication controller further is coupled to the second connector and transmits data via the second connector.

12. The display device as claimed in claim 11, wherein the second connector is implemented as a USB connector.

13. The display device as claimed in claim 11, wherein the second connector is implemented as a Bluetooth connector.

14. The display device as claimed in claim 11, wherein the second connector is implemented as a 1394 connector.

15. The display device as claimed in claim 11, wherein the second connector is implemented as a local area network connector.

16. The display device as claimed in claim 11, wherein the second connector is implemented as a wireless local area network connector.
